(19) United States
(12) Patent Application Publication
(10) Pub. No.: US 2010/0161564 A1
(43) Pub. Date: Jun. 24, 2010

(54) CLUSTER DATA MANAGEMENT SYSTEM AND METHOD FOR DATA RECOVERY USING PARALLEL PROCESSING IN CLUSTER DATA MANAGEMENT SYSTEM

(75) Inventors: Hun Soon Lee, Daejeon (KR); Mi Young Lee, Daejeon (KR)

Correspondence Address: AMPACC Law Group, 3500 188th Street S.W., Suite 103, Lynnwood, WA, 98037, US

(73) Assignee: Electronics and Telecommunications Research Institute, Daejeon (KR)

(21) Appl. No.: 12/543,065

(22) Filed: Aug. 18, 2009

(30) Foreign Application Priority Data
Dec. 18, 2008 (KR) 10-2008-0129637

(51) Int. Cl. G06F 17/30

(52) U.S. Cl. 707/674; 707/E17.007; 707/E17.01

(57) ABSTRACT

Provided is a method for data recovery using parallel processing in a cluster data management system. The method includes arranging a redo log written by a failed partition server, dividing the arranged redo log by columns of the partition, and recovering data parallelly on the basis of the divided redo log and multiple processing unit.

### CROSS-REFERENCE TO RELATED APPLICATIONS

This application claims priority under 35 U.S.C. §119 to Korean Patent Application No. 10-2008-0129637, filed on Dec. 18, 2008, in the Korean Intellectual Property Office, the disclosure of which is incorporated herein by reference in its entirety.

### TECHNICAL FIELD

The following disclosure relates to a data recovery method in a cluster data management system, and in particular, to a method for recovering data by parallel processing on the basis of a redo log, which is written by a computing node constituting a cluster data management system, when an error occurs in the computing node.

### BACKGROUND

As the paradigm of Internet services shifts from provider-centered to user-centered with the recent advent of Web 2.0, the market for Internet services such as a User Created Contents (UCC) service and personalized services is rapidly increasing. This paradigm shift demands considerable increases in the amount of data managed to provide Internet services. Thus, efficient management of large amounts of data is necessary to provide Internet services. However, because large volumes of data need to be managed, existing Database Management Systems (DBMSs) are inadequate for efficiently managing such volumes in terms of performance and cost.

To address such a limitation, research is being conducted to increase computing performance by connecting low-cost computing nodes and provide higher performance and higher availability with software.

Examples of cluster data management systems developed are Bigtable and HBase. Bigtable is a system produced by Google that is being applied to various Google Internet services. HBase is a system being actively developed in an open source project by Apache Software Foundation along the lines of the Google's Bigtable concept.

FIG. 1 is a block diagram of a cluster data management system according to the related art. FIG. 2 is a diagram illustrating the model for data storing and serving of FIG. 1.

Referring to FIG. 1, a cluster data management system 10 includes a master server 11 and partition servers 12-1, 12-2, . . . , 12-n.

The master server 11 controls an overall operation of the corresponding system.

Each of the partition servers 12-1, 12-2, . . . , 12-n manages a service for actual data.

The cluster data management system 10 uses a distributed file system 20 to permanently store logs and data.

Unlike the existing data management systems, the cluster data management system 10 has the following features in order to optimally use computing resources in processing user requirements.

First, while the most of existing data management systems stores data in a row-oriented manner, the cluster data management system 10 stores data in a column (or column group)-oriented manner (e.g., C1, C2, . . . , Cr, Cs, Ct, . . . , Cn), as illustrated in FIG. 2. The term ‘column group’ means a group of columns that have a high probability of being accessed simultaneously. Throughout the specification, the term ‘column’ is used as a common name for a column and a column group.

Secondly, when an insertion/deletion request causes a change in data, an operation is performed in such a way as to add data with new values, instead of changing the previous data.

Thirdly, an additional update buffer is provided for each column to manage the data change on a memory. The update buffer is periodically written on a disk when it reaches a certain size or a certain time has passed since it was lastly recorded.

Fourthly, to overcome the failure, a redo-only log associated with a change is recorded for each partition server (i.e., node) at a location accessible by all computing nodes.

Fifthly, service responsibilities for data to be served are distributed among several nodes to enable services for several data simultaneously. Data are vertically divided to be stored in a column-oriented manner. Also, the data are horizontally divided to a certain size. Hereinafter, for convenience in description, a certain-sized division of data will be referred to as a ‘partition’. Each partition includes one or more rows, and each node manages a service for a plurality of partitions.

Sixthly, unlike the existing data management systems, the cluster data management system 10 takes no additional consideration for disk errors. Treatment for disk errors uses a file replication function of the distributed file system 20.

A low-cost computing node may be easily downed because it has almost no treatment for a hardware-based error. Thus, for achievement of high availability, it is important to treat with a node error effectively on a software level. When an error occurs in a computing node, the cluster data management system 10 recovers erroneous data to the original state by using an update log that is recorded for error recovery in an erroneous node.

FIG. 3 is a flow chart illustrating a data recovery method in the cluster data management system according to the related art.

Referring to FIG. 3, the master server 11 detects whether an node failure has occurred in the partition servers 12-1, 12-2, . . . , 12-n (S310).

If detecting the node failure, the master server 11 arranges a redo log, which is written by a failed partition server (e.g., 12-1), in ascending order on the basis of preset reference information such as a table(a name of table), a row key, and a log sequence number (S320).

Each partition server divides a redo log by partition in order to reduce a disk seek frequency for data recovery based on the redo log (S330).

A plurality of partitions served by the failed partition server 12-1 are allocated in order for a new partition server (e.g., 12-2, 12-3 and 12-5) to manage services (S340).

At this point, redo log path information on the corresponding partition is also transmitted.

Each of the new partition servers 12-2, 12-3 and 12-5 sequentially reads a redo log, reflects an update history on an update buffer, and performs a write operation on a disk, thereby recovering the original data (S350).

Upon completion of parallel data recovery by each of the partition servers 12-2, 12-3 and 12-5, each of the partition servers 12-2, 12-3 and 12-5 resumes a data service for the recovered partition (S360).

This method enables the parallel data recovery by distributing the recovery of the partitions, which are served by one failed partition server 12-1, among a plurality of partition servers 12-2, 12-3 and 12-5.

However, if the respective partition servers 12-2, 12-3 and 12-5 recovering partitions according to log files divided by partitions have a plurality of Central Processing Units (CPUs), the respective partition servers 12-2, 12-3 and 12-5 may fail to well utilize their CPU resources. Also, they may fail to well utilize a data storage model that stores data by physically dividing the data by columns.

### SUMMARY

In one general aspect, a method for data recovery using parallel processing in a cluster data management system includes: arranging a redo log written by a failed partition server; dividing the arranged redo log by columns of the partition; and recovering data on the basis of the divided redo log.

In another general aspect, a cluster data management system restoring data by parallel processing includes: a partition server managing a service for at least one or more partitions and writing a redo log according to a service of the partition; and a master server dividing the redo log by columns of the partition in the event of a partition server failure, and selecting the partition server for restoring the partition on the basis of the divided redo log.

Other features and aspects will be apparent from the following detailed description, the drawings, and the claims.

### BRIEF DESCRIPTION OF THE DRAWINGS

FIG. 1 is a block diagram of a cluster data management system according to the related art.

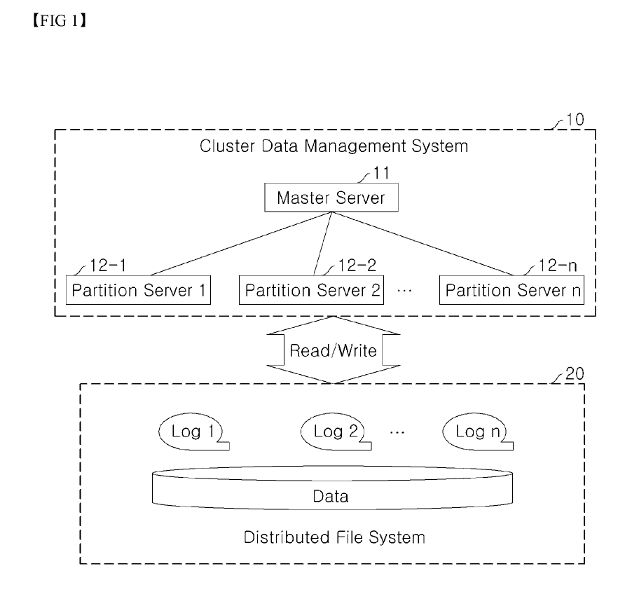

FIG. 2 is a diagram illustrating the model for data storing and serving of FIG. 1.

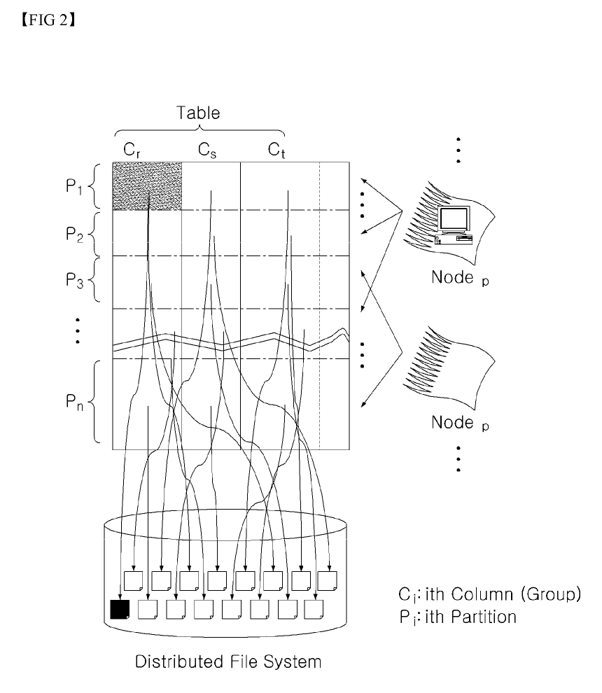

FIG. 3 is a flow chart illustrating a data recovery method in a cluster data management system according to the related art.

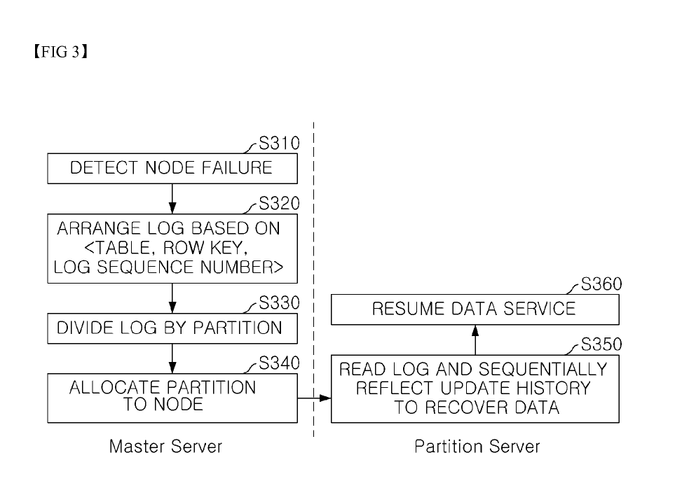

FIG. 4 is a block diagram illustrating a recovery method in a cluster data management system according to an exemplary embodiment.

FIG. 5 is a diagram illustrating arrangement of a redo log of a master server according to an exemplary embodiment.

FIG. 6 is a diagram illustrating division of a redo log of a master server according to an exemplary embodiment.

FIG. 7 is a flow chart illustrating a data recovery method in a cluster data management system according to an exemplary embodiment.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Throughout the specification, the term ‘column’ is used as a common name for a column and a column group.

A method for recovering a failure of a partition server (i.e., node) according to exemplary embodiments uses the feature that stores data by physically dividing the data by columns.

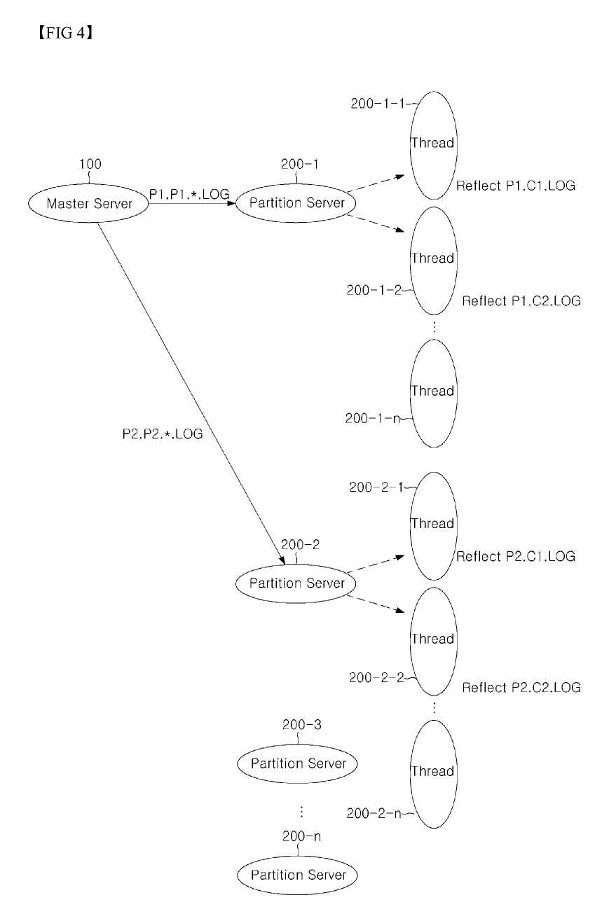

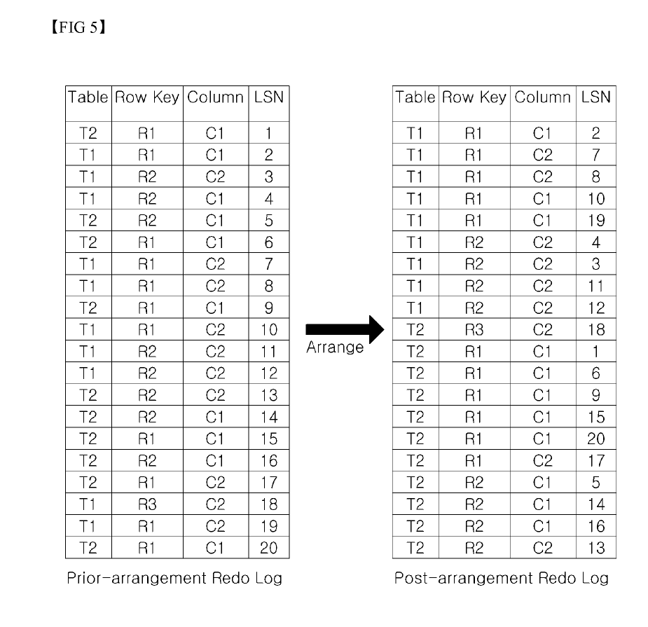

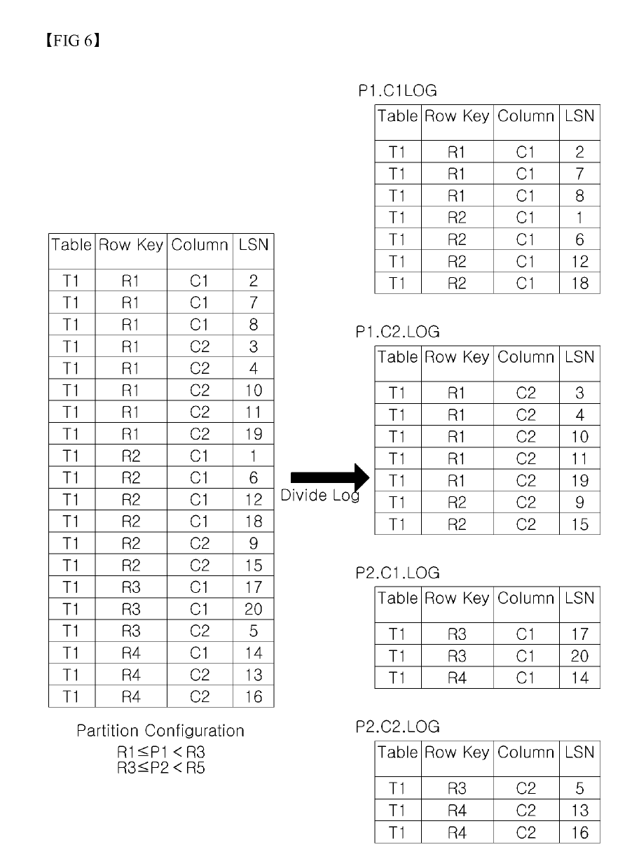

FIG. 4 is a block diagram illustrating a failure recovery method in a cluster data management system according to an exemplary embodiment. FIG. 5 is a diagram illustrating arrangement of a redo log of a master server according to an exemplary embodiment. FIG. 6 is a diagram illustrating division of a redo log of the master server according to an exemplary embodiment.

Referring to FIG. 4, a cluster data management system according to an exemplary embodiment includes a master server 100 and partition servers 200-1, 200-2, . . . , 200-n.

The master server 100 controls each of the partition servers 200-1, 200-2, . . . , 200-n and detects whether a failure occurs in the partition servers 200-1, 200-2, . . . , 200-n. If a failure occurs in one of the partition servers 200-1, 200-2, . . . , 200-n, the master server 100 divides a redo log, which is written by the failed partition server, by columns of partitions. Using the divided redo log, the master server 100 selects a new partition server that will restore/serve partitions served by the failed partition server.

For example, if a node failure occurs in the partition server 200-3, the master server 100 arranges a redo log, written by the partition server 200-3, in ascending order on the basis of preset reference information.

Herein, the preset reference information includes a table, a row key, a column, and a Log Sequence Number (LSN).

The master server 100 divides the arranged redo log into partitions (e.g., P1.C1.LOG, P1.C2.LOG, P2.C1.LOG, and P2.C2.LOG) by columns (e.g., C1 and C2) of partitions (e.g., P1 and P2) served by the failed partition server 200-3, and selects partition servers (e.g., 200-1 and 200-2) that will serve partitions P1 and P2 served by the failed partition server 200-3.

The master server 100 allocates the partitions P1 and P2 respectively to the partition servers 200-1 and 200-2. That is, the master server 100 allocates the partition P1 to the partition server 200-1, and allocates the partition P2 to the partition server 200-2.

The master server 100 transmits path information on files P1.C1.LOG, P1.C2.LOG, P2.C1.LOG and P2.C2.LOG, in which the divided redo log is stored, to the selected partition servers 200-1 and 200-2. That is, the master server 100 requests the partition server 200-1 to serve the partition PI and transmits path information on the P1-related divided redo log files P1.C1.LOG and P1.C2.LOG to the partition server 200-1. Likewise, the master server 100 requests the partition server 200-2 to serve the partition P2 and transmits path information on the P2-related divided redo log files P2.C1.LOG and P2.C2.LOG to the partition server 200-2.

Each of the partition servers 200-1, 200-2, . . . , 200-n manages a service for at least one or more partitions, and records a redo log for update in a file (e.g., a redo log file).

Each of the partition servers 200-1, 200-2, . . . , 200-n is allocated a partition to restore and serve, and receives path information on the divided redo log file (i.e., a basis for restoration of the corresponding partition) from the master server 100.

Each of the partition servers 200-1, 200-2, . . . , 200-n restores the partition allocated from the master server 100, on the basis of the redo log recorded in the divided redo log file corresponding to the received path information.

For restoration of the partition, each of the partition servers 200-1, 200-2, . . . , 200-n generates a thread (200-1-1, . . . , 200-1-n, 200-2-1, . . . , 200-2-n, 200-n-1, . . . 200-n-n) corresponding to the divided redo log file, and performs parallel data recovery by use of the redo log recorded in the file divided through the generated thread (200-1-1, . . . , 200-1-n, 200-2-1, . . . , 200-2-n, 200-n-1, . . . 200-n-n).

For example, the selected partition server 200-1 generates a thread (e.g., 200-1-1, 200-1-2) corresponding to the divided redo log file (P1.C1.LOG, P1.C2.LOG), and performs partition restoration (i.e., data recovery) on the basis of the redo log recorded in the redo log file divided through the generated thread (200-1-1, 200-1-2).

Likewise, the selected partition server 200-2 generates a thread (e.g., 200-2-1, 200-2-2) corresponding to the divided redo log file (P2.C1.LOG, P2.C2.LOG), and performs partition restoration (i.e., data recovery) on the basis of the redo log recorded in the redo log file divided through the generated thread (200-2-1, 200-2-2).

The ascending-order arrangement for the redo log of the master server is described with reference to FIG. 5. A redo log record written by the failed partition server 200-3 includes tables T1 and T2, row keys R1, R2 and R3, columns C1 and C2, and log sequence numbers 1, 2, 3, . . . , 20. It can be seen from FIG. 5 that a log record written in a prior-arrangement redo log file is arranged in ascending order on the basis of the log sequence numbers.

The master server 100 arranges a redo log record in ascending order (i.e., in the order of T1, T2) on the basis of the table. Thereafter, the master server 100 arranges it ascending order (i.e., in the order of R1, R2, R3 for T1; and R1, R2 for T2) on the basis of the row keys. Thereafter, the master server 100 arranges it ascending order (i.e., in the order of C1, C2 for T1, R1; C1, C2 for T1, R2; C2 for T1, R3; C1, C2 for T2, R1; and C1, C2 for T2, R2) on the basis of the columns.

On the basis of preset partition configuration information, the master server 100 sorts the arranged redo logs by partitions, and sorts the sorted redo logs by columns of the partition.

The redo log division of the master server is described with reference to FIG. 6. A redo log record written by the failed partition server 200-3 includes a table T1, row keys R1, R2, R3 and R4, columns C1 and C2, and log sequence numbers 1, 2, 3, . . . , 20. The redo log is arranged in ascending order according to the process of FIG. 5. Herein, the partitions managing a service in the failed partition server 200-3 are P1 and P2. According to the row range information included in the preset partition configuration information, the partition P1 is greater than or equal to R1 and is smaller than R3; and the partition P2 is greater than or equal to R3 and is smaller than R5.

The master server 100 sorts the arranged redo logs by partitions P1 and P2 on the basis of the preset partition configuration information. The partition configuration information is the reference information used for partition (P1 P2) division, which includes the row range information on the partitions P1 and P2. That is, the partition configuration information includes row range information (e.g., R1<=P1<R3, R3<=P2<R5) that indicates the partition for the log record written in the redo log file.

The master server 100 sorts the redo logs sorted by partitions, by columns C1 and C2 of the partitions P1 and P2.

The master server 100 stores the redo logs, sorted by the columns C1 and C2 of the partitions P1 and P2, in one file. For example, in FIG. 6, P1.C1.LOG is a log file storing only the log record for the column C1 of the partition P1.

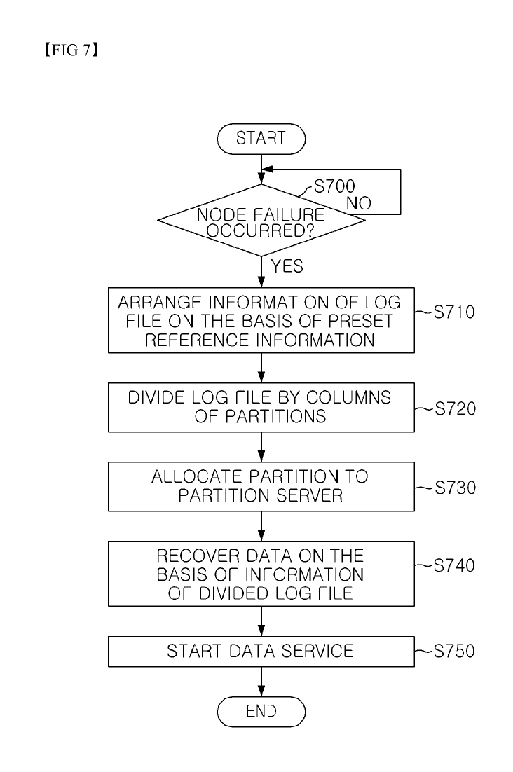

FIG. 7 is a flow chart illustrating a data recovery method in the cluster data management system according to an exemplary embodiment.

Referring to FIG. 7, the master server 100 detects whether a failure occurs in the partition servers 200-1, 200-2, . . . , 200-n (S700).

If a failure occurs in one of the partition servers 200-1, 200-2, . . . , 200-n, the master server 100 arranges the redo log, which is written by the failed partition server 200-3, in ascending order on the basis of preset reference information including tables, row keys, columns, and log sequence numbers (S710).

The master server 100 divides the arranged redo log by columns C1 and C2 of partitions P1 and P2 served by the partition server 200-3(S720).

The log arrangement and division is described with reference to FIGS. 5 and FIG. 6.

The master server 100 selects partitions 200-1 and 200-2 that will serve the partitions P1 and P2 served by the failed partition server 200-3, and allocates the partitions P1 and P2 served by the failed partition server 200-3 to the corresponding servers 200-1 and 200-2 (S730).

That is, the selected partition server 200-1 is allocated the partition P1 from the master server 100, and the selected partition server 20-2 is allocated the partition P2 form the master server 100.

The master server 100 transmits path information on the divided redo log file (P1.C1.LOG, P1.C2.LOG, P2.C1.LOG, P2.C2.LOG) to the partition server (200-1, 200-2).

The partition server (200-1, 200-2) restores the allocated partition (P1, P2) on the basis of the redo log written in the divided redo log file (P1.C1.LOG, P1.C2.LOG, P2.C1.LOG, P2.C2.LOG) (S740).

The partition server (200-1, 200-2) generates a thread (200-1-1, 200-1-2, 200-2-1, 200-2-2) corresponding to the divided redo log file, and performs parallel data recovery on the basis of the redo log written in the divided redo log file (P1.C1.LOG, P1.C2.LOG, P2.C1.LOG, P2.C2.LOG) through the generated thread (200-1-1, 200-1-2, 200-2-1, 200-2-2).

Thereafter, the partition server (200-1, 200-2) starts a service for the data-recovered partition (S750).

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method for data recovery using parallel processing in a cluster data management system, the method comprising:
arranging a redo log written by a failed partition server;
dividing the arranged redo log by columns of the partition; and
recovering data on the basis of the divided redo log.

2. The method of claim 1, wherein the arranging of a redo log comprises:
arranging the redo log in ascending order on the basis of preset reference information.

3. The method of claim 2, wherein the preset reference information includes tables, row keys, columns, and log sequence numbers.

4. The method of claim 1, wherein the dividing of the arranged redo log comprises:
sorting the redo log by partitions served by the partition server, on the basis of preset partition configuration information;
sorting the sorted redo log of each partition by columns of each partition; and
dividing a file, in which the sorted redo log of each column is written, by the columns.

5. The method of claim 4, wherein the partition configuration information is reference information used for partition division and includes row range information indicating that each partition is greater than or equal to and smaller than or equal to a row among row information included in the redo log.

6. The method of claim 1, wherein the recovering of data comprises:
selecting a partition server that with serve the partitions served by the failed partition server;
allocating the partition served by the failed partition server to the selected partition server; and
transmitting path information on the file divided by the columns to the selected 10 partition server.

7. The method of claim 6, further comprising:
restoring, by the selected partition server, the partition allocated on the basis of the log written in the file divided by the columns corresponding to the path information.

8. The method of claim 7, wherein the restoring of the partition comprises:
generating, by the selected partition server, a thread corresponding to the file divided by the columns; and
restoring, by the generated thread, data on the basis of the log written in the file divided by the columns.

9. The method of claim 8, wherein the recovering of the data comprises:
performing parallel data recovery by allocating one or more processor(CPU) to each file divided by the columns.

10. A cluster data management system restoring data by parallel processing, the cluster data management system comprising:
a partition server managing a service for at least one or more partitions and writing a redo log according to a service of the partition; and
a master server dividing the redo log by columns of the partition in the event of a failure of partition server, and selecting the partition server for restoring the partition on the basis of the divided redo log.

11. The cluster data management system of claim 10, wherein the master server arranges the redo log in ascending order on the basis of preset reference information.

12. The cluster data management system of claim 11, wherein the preset reference information includes tables, row keys, columns, and log sequence numbers.

13. The cluster data management system of claim 11, wherein the master server sorts the arranged redo log by the partitions on the basis of preset partition configuration information, and sorts the sorted redo log of each partition by columns of the partition.

14. The cluster data management system of claim 13, wherein the master server divides a file, in which the sorted redo log of each column is written, by the columns.

15. The cluster data management system of claim 13, wherein the partition configuration information is reference information used for the partition division and includes row range information indicating that each partition is greater than or equal to and smaller than or equal to a row among row information included in the redo log.

16. The cluster data management system of claim 10, wherein the master server allocates the partition to the selected partition server, and transmits path information on the file divided by columns to the selected partition server.

17. The cluster data management system of claim 16, wherein the partition server restores the partition allocated from the master server on the basis of the log written in the divided file corresponding to the path information.

18. The cluster data management system of claim 17, wherein the partition server generates a thread corresponding to the divided file, and performs parallel data recovery on the basis of the redo log written in the divided file.
